(19) United States
(12) Patent Application Publication
(10) Pub. No.: US 2007/0072648 A1
(43) Pub. Date: Mar. 29, 2007

(54) Method and apparatus for identifying a calling party

(76) Inventor: Daniel Stewart Stoops, Galena, OH (US)

Correspondence Address: Lucent Technologies Inc.;Docket Administrator - Room 3J-219, 101 Crawfords Corner Road, Holmdel, NJ, 07733-3030, US

(21) Appl. No.: 11/233,874

(22) Filed: Sep. 23, 2005

(51) Int. Cl. H04B 1/38; H04M 1/00

(52) U.S. Cl. 455/566

(57) ABSTRACT

A subscriber uploads to a hosted Web site an image of himself that has been taken, for example, by the internal camera of his mobile terminal. Through interaction with the Web site, the subscriber is able to manipulate that image by animating certain facial features and/or selecting different static or animated backgrounds and optional audio background. The resultant image is stored as a facetone file and is pushed or made available to users to download. The pushed or downloaded facetone file is stored in a user's mobile terminal in association with the subscriber's identity as per in the terminal's address book. When an incoming call is received and is recognized as being from a user having an associated facetone file, that facetone file is triggered and the facetone is displayed on the mobile terminal's display screen enabling the user to easily identify the calling party.

### TECHNICAL FIELD

The invention relates to telecommunications.

### BACKGROUND OF THE INVENTION

The ability to determine the identity of a calling party before answering an incoming call on a communications terminal has become increasing ingrained in telephony services with the availability to subscribe to a caller ID service on landline telephones and the almost universally provided calling party number on mobile terminals. On landline telephones, not only is the phone number of the calling party available to those who subscribe to caller ID services, but the name of the registered owner of the landline or mobile terminal from which the incoming call is originating is now commonly provided. On mobile terminals, either the telephone number of the calling party is usually displayed, or if the incoming call originates from a telephone number stored in the mobile terminal's address book, the name or “tag” associated with that telephone number in the address book is displayed on the mobile terminal's display screen. The association of the incoming call's caller ID with an entry in the mobile terminal's address book may also trigger a particular ringtone that the called party has selected to be associated with the calling party. When unique ringtones are assigned to different entries stored in a mobile terminal's address book, the called subscriber doesn't even have to look at his or her mobile terminal to identify the calling party, but only needs to audibly recognize the ringtone to identify who is calling.

Although assigning different ringtones to different entries in the address book is a useful way of providing the identity of the calling party to the called party, if the called party is distracted during the ringing cycle he might be unable to recognize and identify a distinctive ringtone with a calling party's identity. Also, if the called party has a large number entries in his address book, with each being associated with its own distinctive ringtone, it could be difficult for the called party to quickly associate the ringtone being played with the calling party's identity. A less confusing and more fail proof method of providing a calling party's identity to a called party is thus desirable.

### SUMMARY OF THE INVENTION

In an embodiment of the present invention, a communications device, such as a mobile terminal, upon receiving an incoming call and identifying the calling party from the incoming number, retrieves a stored image of the calling party from its internal memory and delivers it for display on a video screen associated with the communications device. The image can be a still image of the calling party or it can be a moving image of the calling party. The video image can be an actual video clip of the calling party or it can be still image that has been manipulated by the calling party when it was created through animation and/or selection of various still or moving backgrounds. The called party, by visually observing the “facetone” image displayed on his communication device's video screen when he receives an incoming call can thus easily recognize and identify the calling party.

A facetone is created by a subscriber by uploading an image or video clip of himself to a network server, where the image or video clip has been taken, for example, by a mobile terminal with an internal camera. Once submitted to the server, the subscriber can select whether he wants to animate his static image and, if so, how to animate it and, optionally, onto what static or animated background he wants to superimpose his facial or full-body image. The resultant facetone, whether a video clip, an animated image, or a still image, is then either pushed to the terminals of users the subscriber designates, and/or is stored it in a database and made available for downloading into the terminals of parties the calling party is likely to call. When pushed or downloaded to a user, the facetone is stored in association with the subscriber's entry in the address book of that user's terminal. When a call from the subscriber is received by such a user/called party, the facetone is triggered and is displayed on the called party's terminal. In creating the facetone, the subscriber can also create an associated audio file, which can be a separate file or can be integrated with the facetone file. If it is a separate file, it is uploaded to the network server and pushed or downloaded into the terminals of the potential called parties together with the facetone file. The audio file can be an audio clip of the subscriber talking or can be an excerpt of music selected by the subscriber. Thus, in addition to triggering a facetone when an incoming call is recognized as being in the called party's address book, the incoming call triggers playing of the associated audio file through the terminal's speaker while the facetone is being displayed on the terminal's screen. Alternatively, a normal ringing signal, or a particular ringtone that is stored and associated with the calling number can be played when triggered by the recognition of the calling party as being in the called party's address book.

In alternate example embodiments, the incoming call can be received by a wireline terminal and the calling party's static or moving facetone (with an associated audio file, if there is one) can be retrieved from storage in response to the calling party's caller ID information, and displayed on a screen associated with that terminal (and, the associated audio file played through a speaker). Alternatively, the stored facetone (and associated audio file) can be pushed by that terminal to another device that has a screen (and speaker) such as a PC, TV, or even a home appliance, the latter even being a home appliance which primary function is not to display information but which has a built-in display screen for other purposes, such as a refrigerator, where the screen may be there for retrieving recipes, etc. The audio file can also be pushed to another device that has a speaker, such as a radio. Further, in alternate example embodiments, the facetone (and optional audio file) can be transmitted to the called party's mobile or wireline terminal contemporaneously with the ringing signal rather than being pushed or downloaded to the terminal to be stored for later triggering in response to an incoming call.

### BRIEF DESCRIPTION OF THE DRAWING

FIG. 1 is a flowchart showing the methodology of publishing and downloading a facetone; and

FIG. 2 is a block diagram showing an embodiment of a network solution that creates a facetone from a static or moving image received from a subscriber's mobile terminal and pushes or download is that facetone to a user's mobile terminal for later triggering when that terminal receives a call from the subscriber.

### DETAILED DESCRIPTION

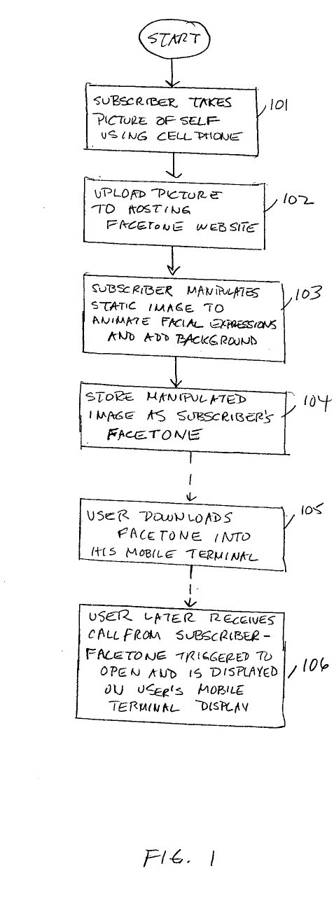

In an illustrative embodiment, a network-hosted service enables a user to create a facetone and either push a file containing that facetone to selected users, or “publish” that facetone for later downloading by end-users. A flowchart illustrating the methodology of creating a facetone and making it available to users is shown in FIG. 1. At step 101, a subscriber to the facetone service initiates the creation of his facetone by taking a digital picture of himself using, for example, a cell phone with a built-in camera. That picture can be a static “still” picture, or can be a full motion video clip. At step 102, the digital facial or full-body picture of the subscriber is uploaded to the hosting facetone site. That site, through its various servers and interfaces, as will be described, enables subscribers to upload video clips or static images. At step 103, using commercially available software residing on a network server, the subscriber optionally is able to manipulate the uploaded static image, for example, by adding facial gestures, animating bodies, and/or adding a static or moving background. The resultant facetone file containing the manipulated and animated image or the uploaded video clip is then, at step 104, “published” by storing it for later downloading by all users or only those authorized by the subscriber to download it. Alternatively, or in addition, the facetone file is pushed to users that the subscriber has designated by providing the identities of such user's or the phone numbers of their mobile terminals. In addition, that network site allows subscribers to upload an audio file to be associated with the facetone file, or to select an audio file to be associated with the facetone from a list of possible available and licensed songs, song segments, or other audio files containing sound effects or other background. That audio file can be incorporated into the facetone file. Alternatively, the associated audio file can be separately pushed to designated users together with the facetone file, or downloaded together with the facetone file by a user who later accesses the network site. At step 105, for purposes of this exemplary embodiment, it is assumed that an authorized user downloads the facetone file and any associated audio file, to his mobile terminal, for example, where it is stored in association with the identity of the subscriber who has created the facetone. When, at step 106, the user receives an incoming call from the subscriber that has originated from a phone number stored in the user's address book, the stored facetone file and any associated audio file are triggered to open. The facetone is then displayed on the user's mobile terminal display(s) while the audio file is played through the terminal's speaker.

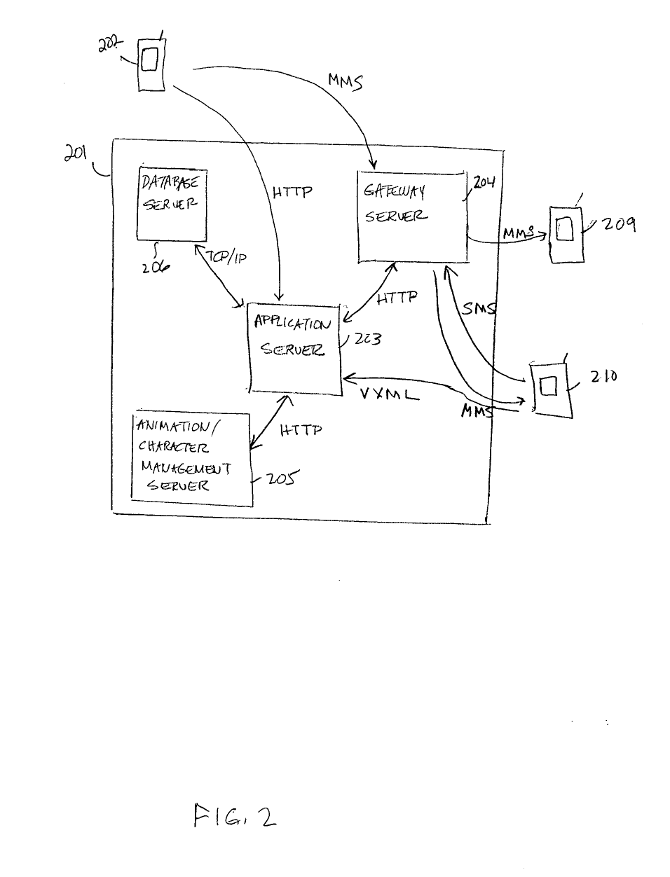

FIG. 2 is a block diagram of a Web site 201 that hosts a facetone service in which digital still or video images are uploaded by a subscriber, optionally manipulated, and pushed to designated users, or stored in a database for later downloading by users. After a subscriber at mobile terminal 202 has taken a picture of himself through his mobile terminal's camera, or through any other methodology, the digital image is uploaded as a JPEG file, for example, to Web site 201 through a Web browser internal to terminal 202 using, for example, the Internet standard HTTP (Hypertext Transfer Protocol) or HTTPS (Hypertext Transfer Protocol—Secure). The image file is uploaded directly to Web application server 203 within site 201, which as will be described, creates the facetone file in response to input selections made by the subscriber through his mobile terminal 202 that enable the subscriber to manipulate that image. Alternatively, the digital image still or video can be uploaded from the subscriber's mobile terminal 202 to Web site 201 within an MMS (Multimedia Message Service) signal sent to a messaging gateway server 204. Messaging gateway server 204 transforms mobile terminal MMS and SMS (Short Message Service) mobile terminal standard communication-formatted signals into signals formatted in accordance with Internet protocols, such as HTTP. The transformed HTTP output of messaging gateway 204 is then inputted to the Web application server 203.

The image captured by Web application server 203 is optionally manipulated by the subscriber via an animation/character management server 205. Commercially available software running on animation/character management server 205 enables the subscriber to make selections through his Web browser running on his mobile terminal 202 via interactions with the Web application server 203 in order to manipulate and/or animate the static image. Thus, for example, the facial features can be altered to wink in an animated manner, the mouth can be made to appear to move, and if the image is a full body picture of the subscriber, the body can be animated. Further, the face or figure can be superimposed on various backgrounds that can be static or moving. Commercially available products to perform such functionality include the Veepers™ technology from Pulse Entertainment, Inc., and Reallusion's It'sMe product. Once the subscriber has completed manipulating the image, the resultant facetone file is stored by Web application server 203 is a database server 206.

In a similar manner, a separate audio file can be uploaded and stored together with or separately with the facetone file. The subscriber can also select using the Web browser on his mobile terminal, background sounds or a song segment from a list of licensed and available selections, for example, to accompany the facetone image.

If the image captured by the subscriber is not a static image but is instead a video clip, that video clip can be uploaded from the subscriber's mobile terminal as a MMS signal sent to gateway server 204. Gateway server 204 then converts that MMS signal into an HTTP-formatted signal for transmission to the Web application server 203. The digital video clip can either be manipulated as the facetone by application server 203 I conjunction with animation/character management server 205 and stored in database server 206.

Once the facetone has been stored in database server 206 it is pushed or pulled to users. If the subscriber wants certain users to receive the facetone, he instructs the Web application server to send the facetone to designated endpoints, whether mobile terminals or not. These instructions can be directly provided to the Web application server 203 through the Web browser running on the subscriber's mobile terminal 202 or through another client (not shown). Alternatively, these instructions can be provided as an SMS message sent from the subscriber's mobile terminal to gateway server 204. These instructions contain the identities, such as the mobile telephone numbers, of those user's who are to receive the facetone (and associated audio file, if any). The application server 203 will then retrieve the facetone file from database server 206 and transfer it to gateway server 204, which creates an MMS message containing the facetone. Gateway server 204 then sends the file to the mobile terminal of designated users, such as, for example, the user of mobile terminal 209. When received by mobile terminal 209, it is stored in memory and associated with the subscriber's entry in the terminal's address book. Alternatively, the facetone file can be directly sent by application server 203 using HTTP to an Internet-enabled device that a user might be using in conjunction with any type of communication device.

Rather than pushing the facetone to mobile or other terminals of designated users, the facetone can be made available to either users who have been granted permission to pull (download) the facetone, or to any user who accesses the facetone Web site 201. For example, a user having a mobile terminal 210 can send an SMS message requesting a subscriber's facetone. That message containing the name, for example, of the subscriber, is received by gateway server 204, which in turn converts the MMS message to an HTTP request and forwards it to the application server 203. Using the name of the subscriber as an index into database server 206, the facetone file is retrieved and transferred to gateway server 204 where it is converted to an MMS message and sent back to the requesting mobile terminal 210. As noted above, the facetone file (and any associated audio file) is stored in association with the subscriber's entry in the terminal's address book.

When an incoming call from the subscriber is received by either mobile terminal 209 or 210, the subscriber's caller ID is recognized as an entry in the address book and the facetone file (and any associated audio file) is triggered to run and play on the called mobile terminal's display screen, thereby enabling the called user to “see” who is calling.

Although the illustrative embodiment describes the facetone being created by the subscriber through his mobile telephone, it should be noted that any other communications device could be used to upload a digital still or video image to the facetone Web site 201. For example, the image could be created in a digital camera, downloaded into the subscriber's PC, and forwarded to the Web application server 203. The image could then be animated/manipulated by the subscriber via selections made through that PC.

Further, although the facetone is described as being downloaded into a user's mobile telephone in response to a request made through an SMS message that is received by gateway server 204, the user alternatively could make the request through analog voice or touch-tone commands that are translated into a VXML format and sent directly to application server 203.

Further, although the facetone has been described as being pushed or pulled into a user's mobile terminal for display thereon when the subscriber subsequently calls that users, the facetone can be pushed or pulled into any other communication device, wireline or wireless, that has its own or an associated display screen. When an incoming call is recognized as being from a subscriber via caller ID, the subscriber's facetone can be displayed on that display screen or it can be pushed to any other connected device that has its own display screen whether or not that other connected device is one that one would ordinarily consider a device for telecommunications. For example, the facetone could be pushed to a home appliance having a display screen, such as a refrigerator, a washing machine, or to a PC.

Further, although the facetone is described as being pushed or downloaded to a user so that it can be triggered on a later call from the subscriber who created the facetone, as the bandwidth capabilities of wireline and wireless networks increases, the facetone could be transmitted to the user's terminal contemporaneously with the ringing signal. Thus, when the network recognizes that a subscriber to a facetone service is placing a call to a user that has the bandwidth capability to receive a file containing a facetone, it can retrieve that file from a network database and transmit it together with the ringing signal to the called user's terminal where it is displayed.

The preceding merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagram herein represents a conceptual view illustrating the principles of the invention. Similarly, it will be appreciated that the flow chart represents various processes which may be substantially represented in computer readable medium and so executed by a computer or processor, whether or not such computer or processor is explicitly shown.

The functions of the various elements shown in the FIG. 2., including functional blocks labeled as “servers” may be provided through the use of dedicated hardware as well as hardware capable of executing software in association with appropriate software.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

The invention claimed is:

1. A method comprising:
displaying a facetone of a caller who is associated with an origin of an incoming call, wherein the facetone comprises an image of the caller.

2. The method of claim 1 wherein the facetone is displayed in response to receiving an indication of the origin of the incoming call.

3. The method of claim 2 wherein the facetone further comprises an audio clip that is played when the facetone is displayed.

4. The method of claim 2 wherein a separate audio clip associated with the facetone is played when the facetone is displayed.

5. The method of claim 1 wherein the facetone comprises an animated image of the caller that has been animated from a static image of the caller.

6. The method of claim 1 wherein the facetone comprises a static image of the caller.

7. The method of claim 1 wherein the facetone comprises a video clip.

8. The method of claim 2 wherein the facetone is stored as a file in a memory and is retrieved from the memory for displaying when the indication of the origin of the incoming call is received.

9. The method of claim 1 wherein the image of the caller is displayed on a screen associated with a terminal that receives the incoming call.

10. The method of claim 1 wherein the image is pushed to a device separate from a terminal that receives the incoming call for display on a screen associated with that device.

11. The method of claim 1 wherein the facetone is received contemporaneously with receiving a ringing signal that is signaling presence of the incoming call.

12. A method comprising:
receiving an image of a subscriber;
storing the image as a facetone; and
sending the facetone to a terminal of a user so that when an incoming call is recognized by the terminal as coming from the subscriber the facetone will be displayed.

13. The method of claim 12 wherein the facetone is sent in response to a request received from the user.

14. The method of claim 12 wherein the facetone is sent to the terminal of the user in response to an instruction to send it to the user received from the subscriber.

15. The method of claim 12 wherein the received image comprises a static image.

16. The method of claim 15 further comprising manipulating the static image in response to instructions received from the subscriber in order to create an animated image, the animated image comprising the facetone.

17. The method of claim 12 wherein the received image comprises a video clip.

18. Apparatus comprising:
means for receiving an image of a subscriber;
means for storing the image as a facetone; and
means for sending the facetone to a terminal of a user so that when an incoming call is recognized by the terminal as coming from the subscriber the facetone is displayed.

19. The apparatus of claim 18 wherein the facetone is sent in response to a request received from the user.

20. The apparatus of claim 18 wherein the facetone is sent to the terminal of the user in response to an instruction to send it to the user received from the subscriber.

21. The apparatus of claim 18 wherein the received image comprises a static image.

22. The apparatus of claim 21 further comprising means for manipulating the static image to create an animated image, the means for manipulating being response to instructions received from the subscriber in order to create an animated image, animated image comprising the facetone.

23. The apparatus of claim 18 wherein the received image comprises a video clip.
